(19) United States
(12) Patent Application Publication
(10) Pub. No.: US 2009/0242007 A1
(43) Pub. Date: Oct. 1, 2009

(54) Adjustable arm cane

(76) Inventors: Chetan Singh Heyer, Concord, CA (US); Chandrika C. Heyer, Concord, CA (US)

Correspondence Address: Chetan Singh Heyer, 1486 Fox Hollow Court, Concord, CA, 94521, US

(21) Appl. No.: 12/080,373

(22) Filed: Apr. 1, 2008

(51) Int. Cl. A61H 3/02

(52) U.S. Cl. 135/71

(57) ABSTRACT

A light-weight portable adjustable arm cane for the purpose of providing support for the torso and extremities for use in a seated or standing position, the arm cane comprising a primary tubular carrier member, a secondary tubular foot member, a spring, a pipe base attached to the bottom of the secondary tubular foot member, an underarm grip, and an adjustable strap. The arm cane can be adjusted by using a spring or a pin inserted into parallel adjacent holes in the two tubular members.

### BACKGROUND OF THE INVENTION

1. Field of the Invention

The invention relates to a portable support device which provides support sufficient to relieve upper, middle and lower back pain in human beings and/or to improve alignment of vertebrae. The invention can be used almost anywhere, in any setting to support a person's torso and extremities while in a seated or standing position. The device is useful for persons recovering from back surgery or back injury, those with chronic back pain, those who are overweight, those who have poor posture, those who spend a large amount of times in a seated position, such as in cars or at desks, or those who have reason to need additional back support for any reason. This is especially important since backaches and back pain are a frequent occurrence in modern-day society.

For instance, a person recovering from back surgery often requires extra support to relieve back pain. Persons may also experience back strain when seated in a car or an improperly designed chair. Back strains can be avoided by using small canes to provide extra support. This can be particularly important for persons who perform deskwork such as secretaries, draftsmen, and the like whose seating arrangements do not provide proper support. The usual desk chair used by such persons has a generally horizontally disposed seat, a generally vertically disposed backrest and no independent height adjustment for the arm rests. Similarly, cars often lack the requisite support devices to relieve back pain.

Additionally, the present invention can be used to support those who carry heavy backpacks, such as servicemen. For instance, the arm cane can support a serviceman's back while seated with a backpack on. Thus relieving him/her from carrying the full weight of the load.

The present invention provides a portable support device which may be used with any chair, bench or car seat to provide acceptable support for a seated person. The present invention also provides a portable support device which may be used with any table, desk or other surface to provide acceptable support for a standing person.

2. Description of Related Technology

Some portable technology has been created for the purpose of relieving back pain while in a seated position. Each of the related technologies are designed to be attached to a seat by a strap or a more rigid mechanism. Further, each invention is attached to a base member. The present invention is free standing, adjustable, lightweight, and dissimilar from other devices designed to support the back for other reasons.

U.S. Pat. Nos. 7,237,844 and 7,156,465 teach of a lightweight portable vertebrae decompression support device comprising a pair of arm rests with selectively adjustable members connecting the arm rests and a base member, which is adapted to rest on a seat. The present invention is free standing. It also supports under the armpits directly to lift the torso, as opposed to the device in these patents which just provides support for arms.

U.S. Pat. Nos. 6,988,772 and 6,793,288 teach of a back support displacing a person's weight comprising two axillary rests disposable against the seat back, supporting major muscles. The axillary rests are attached by a base member and the entire device is strapped to a chair back. The present invention has dissimilar structural properties; for instance, one cane can be used or two, and the two canes are not attached by a base member. Further, the present invention does not attach to the back of a chair it is free standing offering more comfort.

### SUMMARY OF THE INVENTION

The present invention is directed to a portable device to provide support for the upper, middle and/or lower back of a human being while in a seated position or standing position by supporting weight of the torso and its extremities. By reducing strain the invention can also assist alignment of the vertebrae.

Other objects, advantages and novel features of the present invention will become apparent from the following detailed description of the invention when considered in conjunction with the accompanying drawings.

### BRIEF DESCRIPTION OF THE DRAWINGS

The drawings show the exemplar embodiments of the invention described herein

FIG. 1 is a view of an exemplary embodiment of the adjustable arm cane and its accessories. Circled Notes 1-12 represent the exemplary embodiment of an adjustable arm cane. Circled Note D is a view of a spring which can be placed within the primary tubular element (9) of the arm cane. Circled Notes A, B and C are rigid spring-extender pipe inserts which can be placed inside of the tubular element next to the spring enable the invention to adapt to persons of different heights. Also FIG. 1 shows an enlarged view of Circled Notes 11 and 12 which represent a pipe base (11) that is affixed to the bottom of the secondary tubular member (10) of the arm cane and also shows a cap end (12) which is affixed to the primary tubular member (9) of the arm cane.

FIG. 2 is a list of Circled Notes for the Adjustable Arm Cane and its Accessories which identify specs of FIG. 1. FIG. 2 specs are just one example of the present invention.

### DETAILED DESCRIPTION OF THE INVENTION

The adjustable arm cane is comprised a primary tubular carrier member (9) being provided with a series of holes and within which is telescopically carried secondary tubular foot member (10) being provided with a series of holes. The primary tubular carrier and secondary tubular foot member can be made out of many substances, such as, but not limited to, PVC piping, metal, metal alloy, wood, or structurally similar substances. At the bottom of the tubular foot member is a pipe base, which is typically made out of rubber, a rubber-like polymer, or other similar substance. Inside the tubular carrier is a spring (D) which fits just inside the diameter of the primary tubular carrier and meets the top of the tubular foot member. The spring has sufficient tensile strength to hold up the torso and extremities of a human being. Springs of varying strength can be placed inside the adjustable arm cane to support persons of different weights. Rigid spring-extender pipe inserts (A, B and C) fit just inside the diameter of the primary tubular carrier and allow the arm cane to adjust to different heights. The rigid spring-extenders can be placed between the spring and the secondary tubular foot member. Alternatively, the spring can be placed between the rigid spring-extenders and the secondary tubular foot member.

The arm cane is fitted with a pin (7). A pin can be inserted into parallel adjacent holes in the two tubular members to stabilize the arm cane at a particular height. The pin can be a simple rod made from metal, wood, metal alloy, plastic or other similar structure which can be manually pushed through the adjacent holes to stabilize the arm crutch. More preferably, the pin would be a wire “spring” loaded pin (7), concealed within the secondary tubular foot member (10). The spring loaded pin can be pushed inside of the secondary tubular foot manual manually to allow the primary tubular carrier member and the secondary tubular foot member to slide together or apart in a telescopic fashion. This can occur once the spring loaded pin is pushed in and when the parallel adjacent holes on the two tubular members are not aligned. When the two tubular members are able to slide back and forth freely, then spring (D) can support the weight of the torso and extremities. Alternatively, once the parallel adjacent holes on the two tubular members are aligned with each other and the wire spring loaded pin, the pin releases though the adjacent holes and the height of the arm crutch is stabilized.

At one end of the primary tubular member there is an underarm grip (4 and 5). The underarm grip comprises a cross pipe (5) which can be made out of many substances, such as PVC piping, metal, metal alloy, wood, or structurally similar substances, and a pipe sleeve arm pad (6) which can be made out of neoprene, soft rubber foam, gel, or another material to provide a sort of cushion for the underarm area. Additionally, the pipe sleeve arm pad can be reinforced by a second pad comprising soft rubber foam, gel, or any another material. Attached to each end of the underarm grip is an adjustable strap (1). The strap can be comprised of any durable material, such as canvas, nylon, cotton, wool, durable fabric-based polymer, or other durable, flexible material. Preferably, the adjustable strap with have a male closure fitting (2) and female closure fitting (3). The male and female closure fittings can be made from plastic, metal or any other suitable material. The adjustable strap can be adjusted to fit around the shoulder and arm of the person using the adjustable arm cane. Once around the shoulder, the arm strap can be tightened around the shoulder to keep help the arm cane in one location while in use. Also the strap is convenient because a person can carry the arm cane easily, just as a person might carry a purse or shoulder bag.

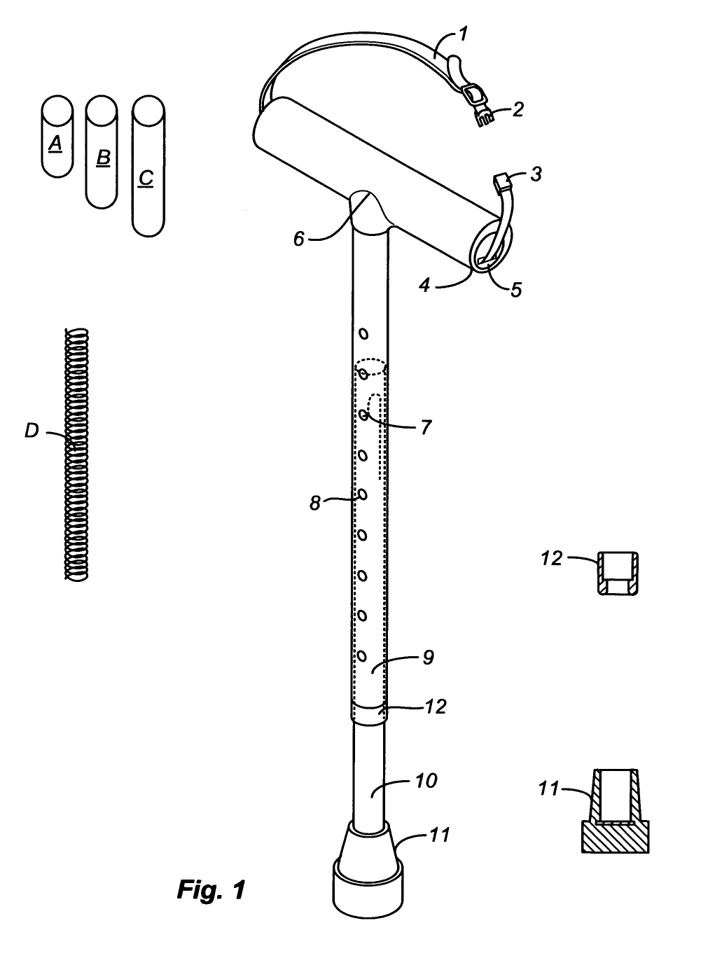

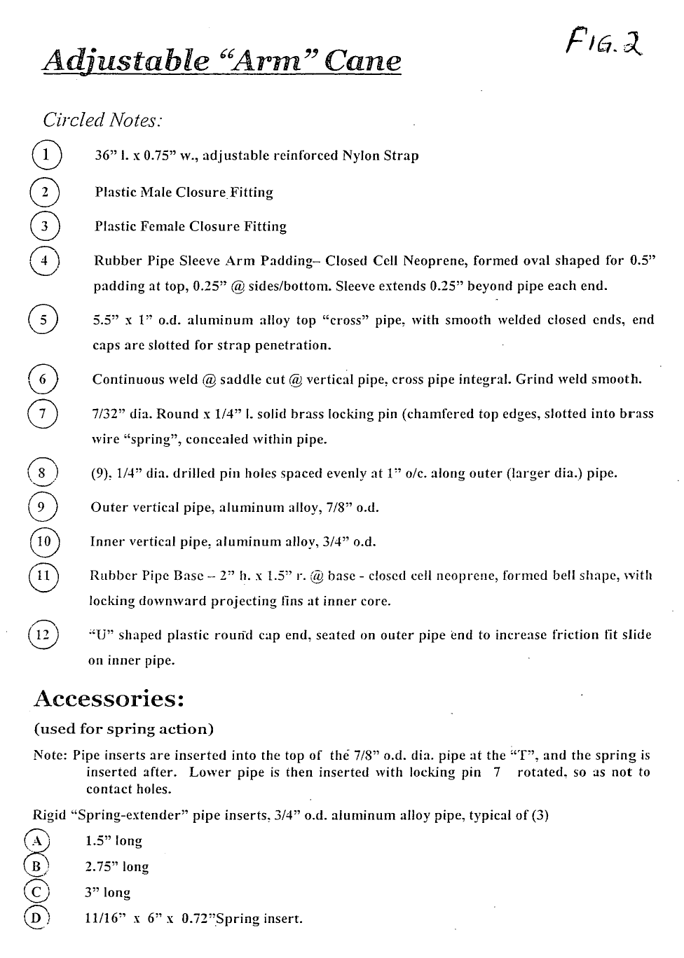

In addition to the length designated in FIG. 1 and FIG. 2, the primary tubular carrier and secondary tubular foot members can be various lengths to allow for use by either children or adults. To use the present invention the underarm grip is placed underneath the armpit. The foot of the cane is then placed on some surface (nearly any surface), including, but not limited to, a table, a ledge, a shelf, a chair, a seat in a car, a desk, a bench, or any other sort of surface. A person can then lean on the arm grip allowing the spring to support the weight of their torso and extremities until reaching a comfortable position. The spring alone can support the weight of the torso and extremities or the cane can be adjusted and stabilized to a specific height by inserting a pin into parallel adjacent holes in the primary tubular carrier and the secondary tubular foot.

Finally, the present invention can be used with or without a spring (D) inside of the primary tubular member. Further, use of the arm strap is optional.

1. A back support device aid readily adjustable for use by individuals of varying sizes, comprising:
(a) a primary tubular carrier member,
(b) a secondary tubular foot member which fits just inside the diameter of the primary tubular member,
(c) a pipe base attached to the bottom of the secondary tubular foot member,
(d) an underarm grip attached to the top of the primary tubular member, and
(e) an adjustable strap attached to the underarm grip,

2. A back support device as in claim 1, wherein:
said primary tubular member and said secondary tubular foot member are made from lightweight sturdy substance, including, but not limited to PVC pipe, aluminum alloy, another metal alloy another lightweight substance, steel, wood or another substance with similar structural integrity.

3. A back support device as in claim 1, wherein:
said adjustable strap is comprised of a substance, including, but not limited reinforced nylon, canvass, durable cotton, some similar reinforced polymer or some similar reinforced fabric.

4. A back support in claim 1, wherein:
(a) the primary tubular member has holes or orifices drilled through the diameter of the tubular members spaced between ¼″ and 2″ apart and the secondary foot member has matching orifices drilled through its diameter,
(b) a means for adjusting and stabilizing the primary tubular member to the secondary tubular member to a specified height.

5. A back support device as in claim 4, wherein:
(a) the size of the hole is ⅛″-⅜″ in diameter, and
(b) a 3/32″- 11/32″ wire “spring” pin which stabilizes the height of the adjustable arm cane is inside of the secondary tubular foot member.

6. A back support device as in claim 5, wherein:
said primary tubular member and said secondary tubular foot member are made from lightweight sturdy substance, including, but not limited to PVC pipe, aluminum alloy, another metal alloy another lightweight substance, steel, wood or another substance with similar structural integrity.

7. A back support device as in claim 5, wherein:
said adjustable strap is comprised of a substance, including, but not limited reinforced nylon, canvass, durable cotton, some similar reinforced polymer or some similar reinforced fabric.

8. A back support device as in claim 1, wherein:
a spring placed inside of the primary tubular member and next to the secondary tubular foot member an underarm grip.

9. A back support device as in claim 4, wherein:
a spring placed inside of the primary tubular member and next to the secondary tubular foot member an underarm grip such that it can support the weight of the torso and extremities.

10. A back support device as in claim 5, wherein:
a spring placed inside of the primary tubular member and next to the secondary tubular foot member an underarm grip such that it can support the weight of the torso and extremities.

11. A back support device as in claim 6, wherein:
a spring placed inside of the primary tubular member and next to the secondary tubular foot member an underarm grip such that it can support the weight of the torso and extremities.

12. A back support device as in claim 7, wherein:
a spring placed inside of the primary tubular member and next to the secondary tubular foot member an underarm grip such that it can support the weight of the torso and extremities.

13. A back support device as in claim 4, wherein:
said primary tubular member and said secondary tubular foot member are made from lightweight sturdy substance, including, but not limited to PVC pipe, aluminum alloy, another metal alloy another lightweight substance, steel, wood or another substance with similar structural integrity.

14. A back support device as in claim 4, wherein:
said adjustable strap is comprised of a substance, including, but not limited reinforced nylon, canvass, durable cotton, some similar reinforced polymer or some similar reinforced fabric.

15. A back support device as in claim 13, wherein:
a spring placed inside of the primary tubular member and next to the secondary tubular foot member an underarm grip such that it can support the weight of the torso and extremities.

16. A back support device as in claim 14, wherein:
a spring placed inside of the primary tubular member and next to the secondary tubular foot member an underarm grip such that it can support the weight of the torso and extremities.
